(19) United States
(12) Patent Application Publication
(10) Pub. No.: US 2009/0199703 A1
(43) Pub. Date: Aug. 13, 2009

(54) POSITIONER FOR DOUBLE-ACTING PNEUMATIC ACTUATOR, DOUBLE-ACTING PNEUMATIC ACTUATOR AND METHOD FOR OPERATING THE DOUBLE-ACTING PNEUMATIC ACTUATOR

(76) Inventors: Dirk Hoffmann, Offenbach (DE); Thomas Karte, Bruchkoebel (DE)

Correspondence Address: SCHIFF HARDIN, LLP;PATENT DEPARTMENT, 6600 SEARS TOWER, CHICAGO, IL, 60606-6473, US

(21) Appl. No.: 12/361,744

(22) Filed: Jan. 29, 2009

(30) Foreign Application Priority Data
Feb. 6, 2008 (DE) 10 2008 007 651.1

(51) Int. Cl. F15B 13/16

(52) U.S. Cl. 91/361

(57) ABSTRACT

In a positioner for a double-acting pneumatic actuator having first and second pneumatically loadable working chambers as well as a movable working part which is shiftable for an actuating movement at a pressure difference in the first and second working chambers, the positioner comprises first and second pneumatic control signals output to the first and second working chambers, respectively. At least one adjusting device for adjusting the first pneumatic control signal for the first working chamber is provided. The adjusting device is designed such that the adjustment of the first control signal according to a control leaves the second control signal unaffected. In a method for operating the double-acting pneumatic actuator, an average pressure value of the first and the second working chambers is determined in a fully regulated state of the actuator. For increasing or reducing respectively a stiffness of the actuator, the average pressure value of the working chambers is increased or decreased, respectively.

### BACKGROUND

The preferred embodiment relates to a positioner for a double-acting pneumatic actuator.

Double-acting pneumatic actuators are frequently used in the process industry. Typical applications of double-acting pneumatic actuators are, for example, concentrated on control functions for which valve flaps or butterfly valves in pipes are to be controlled. A double-acting pneumatic actuator can be formed, for example, by means of an actuating cylinder which is used in particular in power plant technology and which can produce a defined pressure difference in an air duct.

Double-acting actuators have the general advantage to be particularly robust and long-lasting, wherein at the same time, a structurally simple and inexpensive construction is ensured.

Typically, the double acting pneumatic actuators are position-controlled by a so-called electro-pneumatic positioner which converts electrical feedback control signals into a pneumatic control signal, which is supplied to the working chambers of the double-acting pneumatic actuator. The pneumatic working chambers of the double-acting actuator are inversely loaded and are inversely controlled accordingly.

Typically, a double-acting actuator has a working part which is moveable, such as a piston guided within a cylinder, or a diaphragm wall, and which is moved when a pressure difference between the first and the second working chambers of the double-acting pneumatic actuator arises.

It is known that the positioner for operating the pneumatic double-acting actuator puts out two pneumatic control signals and transmits them to the respective working chamber. Normally, a positioner is connected to a supply pressure source of typically 6 bar, wherein in the fully regulated state of the actuator, the average value of the pressure in both working chambers is normally 3 bar.

An example for a double-acting pneumatic actuator is described in DE 100 21 744 A1, wherein the pressure difference between the two working chambers of the actuator is defined as a controlled variable. For adjusting the pressure difference, a proportional valve arrangement is utilized, by means of which the pressure conditions in the working chambers are controlled inversely dependent on one another.

Known positioners for controlling a double-acting pneumatic actuator can be provided with a connection for applying a supply pressure of about 6 bar as well as with two outputs, by means of which two pneumatic control signals are put out to the working chambers of the double-acting actuator. By means of a translationally moveable piston valve, the pneumatic value of the control signal is set inversely at both outputs, whereby a decrease of the first pneumatic control signal results in an increase of the second pneumatic control signal. Insofar, the feedback control of the actuator is realized by generating a pressure difference.

Typically, double-acting pneumatic actuators, which are connected to a supply pressure of about 6 bar, work at a constant average pressure value of 3 bar with respect to the first and second working chamber. These known double-acting pneumatic actuators can carry out fast feedback control cycles, but have the disadvantage to be not load-stiff enough (that is not rigid) due to the compressibility of the operating medium air. If the operating environment of the actuator requires a high load stiffness, as is known, hydraulic actuators are used which are cost-intensive with respect to purchasing and which can not be considered for all applications due to the lack of environmental compatibility of the hydraulic oil.

### SUMMARY

It is an object to overcome the disadvantages of the prior art, and in particular, to provide a positioner which controls a universally usable, double-acting pneumatic actuator and which is operational even when control cycles combined with a high and, in particular, selectable load stiffness are required from the actuator.

In a positioner for a double-acting pneumatic actuator having first and second pneumatically loadable working chambers as well as a movable working part which is shiftable for an actuating movement at a pressure difference in the first and second working chambers, the positioner comprises first and second pneumatic control signals output to the first and second working chambers, respectively. At least one adjusting device for adjusting the first pneumatic control signal for the first working chamber is provided. The adjusting device is designed such that the adjustment of the first control signal according to a control leaves the second control signal unaffected. In a method for operating the double-acting pneumatic actuator, an average pressure value of the first and the second working chambers is determined in a fully regulated state of the actuator. For increasing or reducing respectively a stiffness of the actuator, the average pressure value of the working chambers is increased or decreased, respectively.

### BRIEF DESCRIPTION OF THE DRAWINGS

FIG. 1 shows a schematic diagram of a pneumatic actuator system according to the preferred embodiment comprising a pneumatic double-acting actuator and an electro-pneumatic positioner;

FIG. 2a shows a graphic illustration of the pressure situation during the usage of the method according to the preferred embodiment for an increased stiffness or rigidity of the pneumatic actuator; and

FIG. 2b shows a graphic illustration of the pressure conditions for good dynamic behavior of the pneumatic actuator.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the principles of the invention as illustrated as would normally occur to one skilled in the art to which the invention relates are included.

Accordingly, a positioner for a double-acting pneumatic actuator comprising a first and a second pneumatically loadable working chamber as well as a moveable working part, such as a piston, is provided. The working part can be moved in case of a pressure difference in the first and the second working chamber. The positioner supplies a first and second pneumatic control signal to the first and second working chamber, respectively. According to the preferred embodiment, the positioner has at least one device for adjusting the first pneumatic control signal for the first working chamber, wherein the device is constructed in such a manner that the adjustment of the first pneumatic control signal leaves the second control signal unaffected according to the control. According to the preferred embodiment, the adjustability of the first control signal is hence to be carried out independent from the second control signal, in particular independent from the pneumatic value of the second pneumatic control signal. With the measure according to the preferred embodiment, it is possible to increase the load stiffness of an actuator by simultaneously increasing the pressures within the working chamber, individually and independent from one another, i.e., without necessarily a design-related inverse pressure change in the pneumatic working chambers being involved. Due to an increased pressure in the working chamber, the complete system of the actuator becomes stiffer. By means of the individual adjustability of the pressure in at least one of the working chambers, pressure conditions of, for example, 5.8 bar in the first working chamber and 5.4 bar in the second working chamber can be generated, wherein the generated pressure difference of 0.4 bar causes the desired shifting of the working part of the actuator. Due to the high pressure of more than 5 bar, the actuator obtains a higher stiffness.

In the preferred embodiment of the invention, the second pneumatic control signal is formed by constant pressure of a pneumatic supply source, in particular at the level of 6 bar. In order to adjust the pressure difference between the first and the second working chamber, the first pneumatic control signal can be changed accordingly to generate pressure differences in the range of 6 bar. For this purpose, the device for adjusting the first pneumatic control signal can comprise a current-to-pressure transducer which is connected with a feedback control electronics and, if necessary, a pneumatic amplifier which is connected to the pneumatic supply source. The constant supply pressure according to the second pneumatic control signal remains always unchanged during the adjustment of the first pneumatic control signal by means of the current-to-pressure transducer, for example at 6 bar.

In a further development of the preferred embodiment, the positioner comprises, in addition to a first device for adjusting the first pneumatic control signal for the first working chamber, a second device for adjusting the second pneumatic control signal for the second working chamber. According to the control, the first and the second device are operated here independent from one another, i.e., the positioner generates, by means of its two devices, individually produced pneumatic control signals which are to be supplied to the respective working chamber.

In the preferred embodiment, the first and the second device each have a current-to-pressure transducer, such as a magnetic valve. The current-to-pressure transducer can receive electrical feedback control signals, in particular from a common feedback control electronics. For this, the feedback control electronics has two separate outputs for connecting to the respective current and pressure transducer. By means of the outputs, the feedback control electronics puts out the first and the second electrical feedback control signal.

Preferably, downstream of each current-to-pressure transducer, a pneumatic amplifier is arranged, which is connected to the respective chamber of the pneumatic actuator by means of lines.

In a preferred embodiment, a feedback control electronics of the positioner is connected with one sensor for detecting the pressure of the first and the second chamber, respectively. For this, the pressure sensors can be arranged in a connection line leading from the positioner to the respective working chamber of the actuator. Alternatively, the pressure sensors can be located within the working chamber of the actuator.

In a further development a feedback control electronics of the positioner is connected with a position sensor for detecting the position of a control element, such as a valve element, to be actuated by the actuator.

Furthermore, the preferred embodiment relates to a positioner arrangement for a double-acting pneumatic actuator comprising a first and a second pneumatically loadable working chamber as well as a moveable working part which is accelerated for an actuating movement at a pressure difference in the first and the second working chamber. According to the preferred embodiment, a first positioner is allocated to the first working chamber and a second positioner, which is independent from the first positioner, is allocated to the second working chamber to supply, according to the control, pneumatic control signals, which are independent from one another, to the working chambers. According to the preferred embodiment, the positioner arrangement has two positioners which can be operated independent from one another and which can supply respective, separately calculated pneumatic control signals to the respective working chamber.

Furthermore, the preferred embodiment relates to a double-acting pneumatic actuator, in particular comprising the above mentioned positioner. The double-acting pneumatic actuator has a first and a second pneumatic working chamber as well as a movable working part, such as a piston. The working part can be moved at a pressure difference in a first and a second working chamber. In addition, the positioner puts out the first and the second pneumatic control signal to the first and the second working chamber, respectively. The actuator is connected by means of the positioner with a pneumatic supply source.

In a fully regulated state of the actuator, a (theoretical) average pressure value can be determined with respect to the pressures in the first and the second working chamber. For a conventional double-acting pneumatic actuator, the average pressure value is half of the supply pressure of the pneumatic supply source. According to the preferred embodiment, for increasing the stiffness of the actuator, the at least one positioner is designed for varying the average pressure value of the working chambers, in particular to increase the average pressure value above the half supply pressure of the pneumatic supply source.

The average pressure value of the working chambers is preferably adjustable, preferably between a minimal and an approximately full supply pressure, in particular between 3 bar and up to 5 and 6 bar.

The preferred embodiment relates to a method for operating of a double-acting pneumatic actuator, in particular comprising a first and a second working chamber. Separate pneumatic control signals are applied to the working chambers. In a fully regulated state of the actuator, the average pressure value between the pressures existing in the first and in the second working chamber can be determined. For increasing or reducing the stiffness of the actuator, the average pressure value is increased or decreased, respectively.

Also according to the preferred embodiment the controlling regulator determines which state it should take. This can be, for example, the state “high load stiffness-low dynamics”, or the state “low load stiffness-high dynamics”. The determination of the operating state can take place, for example, by observing the dynamics of the target value input. While a regulator according to the known prior art thus adjusts only the output parameter “pressure difference”, the regulator of the preferred embodiment regulates in addition the output parameter “pressure level”.

In a fully regulated state without the disturbance variable d acting on the actuator, the first and the second working chamber are loaded with the same pressure from the same supply source. For increasing the stiffness of the actuator, the pressures in the chamber are increased above the half supply pressure of the pneumatic supply source.

The method can optionally be implemented in a positioner. Then, in case of a required high stiffness, the positioner can provide high pressure within the chambers, while it is advantageous for good dynamic behavior to decrease the static pressure of the chambers again to, for example, the half supply pressure.

Preferably, the approximately full supply pressure of the pneumatic supply source is applied to the two working chambers, in particular up to 5 or 6 bar, when increased load stiffness is required for the pneumatic double-acting actuator.

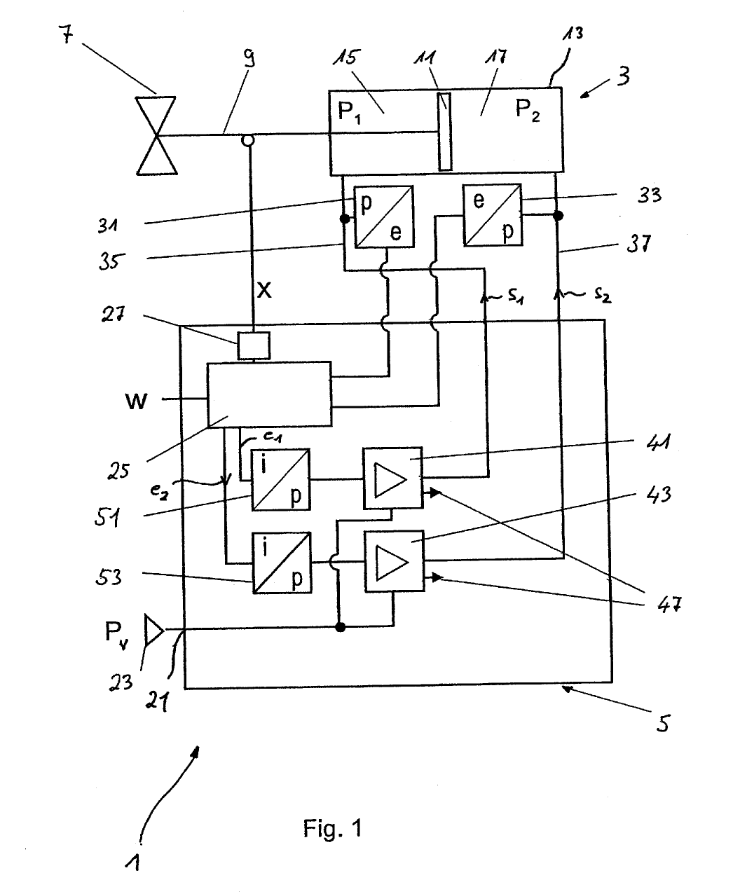

In FIG. 1, an actuator system of the preferred embodiment is generally indicated with the reference number 1. The pneumatic actuator system 1 comprises a pneumatic double-acting actuator 3 and an electro-pneumatic positioner 5, which applies pneumatic control signals s₁ and s₂ of about 1 to 6 bar to the actuator 3. The pneumatic actuator 3 actuates a control valve 7.

The pneumatic actuator 3 has an actuator rod 9, which ends on the actuator side in a piston 11, which divides an outer cylinder 13 of the pneumatic actuator 3 into two working chambers 15, 17.

Depending on which pneumatic values the control signals s₁, s₂ should have, the working chambers 15, 17 are loaded with the pressures p₁, p₂. In case of a pressure difference between p₁ and p₂, a movement of the rod 9 takes place.

The positioner 5 has an input 21 for the connection to a pneumatic supply source 23, which provides a constant supply pressure P_{V} of 6 bar.

Furthermore, the positioner 5 has an input for supplying target data w for the execution of the feedback control by means of a microprocessor 25. The microprocessor 25 is connected with a position sensor 27, which, for detecting the position of the actuator rod 9, accesses the latter and emits a position signal x to the microprocessor 25.

The microprocessor 25 is additionally connected with a first pressure sensor 31 and a second pressure sensor 33 which are supposed to measure the pressures existing in the working chambers 15, 17. In the embodiment shown in FIG. 1, the pressure sensors 31, 33 are arranged in the respective connection line 35, 37, which connects the respective working chamber 15, 17 with one pneumatic amplifier 41, 43, respectively.

The pneumatic amplifiers 41, 43, which are responsible for generating the pressure for the respective control signals s₁, s₂, are both connected to the pneumatic supply source 23. Both pneumatic amplifiers 41, 43 can be bled by means of accordingly activated outputs 47.

The positioner comprises two current-to-pressure transducers 51, 53, to each of which an electrical feedback control signal e₁, e₂ from the microprocessor 25 is supplied via lines.

Based on the electrical feedback control signal e₁, e₂, the current-to-pressure transducer 51, 53 emits a corresponding pneumatic pre-control signal to the pneumatic amplifier 41, 43.

In such a manner, the positioner 5 according to the invention can generate pneumatic control signals s₁, s₂, which are completely independent from one another. Insofar, individual pressures with specified pressure differences can be adjusted within the working chambers 15, 17 to adjust the stiffness or the softness, respectively, of the actuator 3.

In the case that the actuator has to provide a high stiffness, the working chambers 15, 17 are supplied with approximately the full supply pressure Pᵥ so that about 6 bar exist in both chambers. To be able to now execute the desired feedback control, the current-to-pressure transducers 51, 53 can generate a pressure difference in the range of 6 bar by an appropriate control within the working chambers 15, 17.

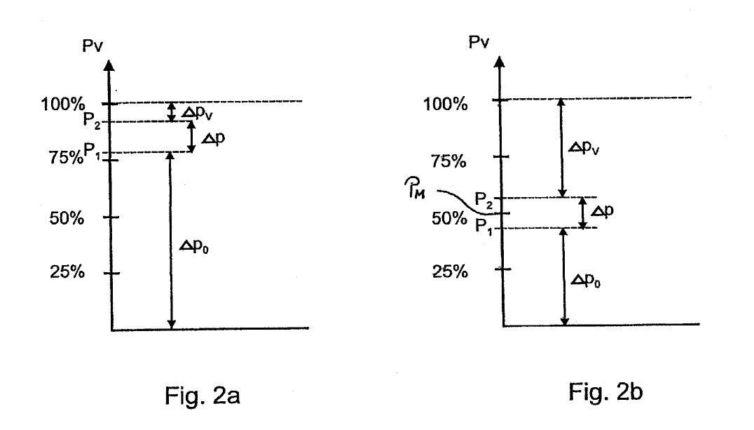

In FIG. 2a a case is indicated in which the approximate supply pressure Pᵥ exists in the working chambers 15, 17. For both pressures p₁, p₂, more than 50% of the supply pressure Pᵥ is directed into the working chambers 15, 17.

For this, either a pressure difference to the maximum supply pressure (ΔP_{V}), the pressure difference in the working chambers (ΔP), or the pressure difference for bleeding (ΔP₀) can be determined and can be used accordingly for the feedback control. An average pressure value P_{M} can easily be determined in both cases (FIG. 2a, 2b). In both cases

Pm=ΔP₀+½ΔP.

To vary the stiffness of the actuator, the positioner system is designed in a manner to be able to change the stiffness of the actuator by either increasing the average pressure value P_{M} for increasing the stiffness or by decreasing it for reducing the stiffness.

In FIG. 2b, the pneumatic actuator 3 is put in an operating state in which it has a good dynamic behavior, and in which the static pressure in the chambers 15, 17 is set again to the half supply pressure P_{V}. Accordingly, the pressure differences ΔP_{V}, ΔP₀ (to the maximum of the supply pressure, to the bleeding pressure) have changed without the pressure difference ΔP in the chambers 15, 17 being changed. In both operating states according to the FIGS. 2a and 2b, the same movement of the piston 11 is ensured, once with a stiff actuator system according to FIG. 2a, and once in a soft actuator system according to FIG. 1a.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1. A positioner for a double-acting pneumatic actuator having first and second pneumatically loadable working chambers as well as a moveable working part which is shiftable for an actuating movement at a pressure difference in the first and the second working chambers, comprising:
first and second pneumatic control signals output to the first and the second working chambers, respectively;
at least one adjusting device for adjusting the first pneumatic control signal for the first working chamber; and
the adjusting device being designed such that the adjustment of the first control signal according to a control leaves the second control signal unaffected.

2. A positioner according to claim 1 wherein the second pneumatic control signal is formed by a constant supply pressure of a pneumatic supply source, the supply pressure remaining unchanged during the adjustment of the first pneumatic control signal wherein the device has a current-to-pressure transducer connected to a feedback control electronics.

3. A positioner according to claim 1 wherein in addition to a first device for adjusting the first pneumatic control signal for the first working chamber, a second device is provided for adjusting the second pneumatic control signal for the second working chamber, the first and the second devices being operated independently from one another according to said control.

4. A positioner according to claim 3 wherein both devices are connected to a common pneumatic supply source, or each of them is connected to its own pneumatic supply source.

5. A positioner according to claim 3 wherein the first and the second device each have a current-to-pressure transducer or a magnetic valve which receives electrical feedback control signals from a common feedback control electronics which generates and emits a first or a second feedback control signal, respectively.

6. A positioner according to claim 5 wherein downstream of each current-to-pressure transducer a pneumatic amplifier is arranged.

7. A positioner according to claim 1 wherein a feedback control electronics of the positioner is connected with a sensor for detecting a pressure in the first and the second chambers.

8. A positioner according to claim 7 wherein a pressure sensor is arranged in a connection line leading from the positioner to the respective working chamber of the actuator.

9. A positioner according to claim 1 wherein a feedback control electronics of the positioner is connected with a position sensor for detecting the position of a control element to be actuated by the actuator.

10. A positioner system for a double-acting pneumatic actuator comprising first and second pneumatically loadable working chambers as well as a moveable working part which is shiftable for an actuating movement at a pressure difference in the first and the second working chambers, comprising:
a first positioner allocated to the first working chamber;
a second positioner which is independent from the first positioner allocated to the second working chamber; and
the first and the second positioners supplying, according to a control, pneumatic control signals which are independent from one another to the respective first and second working chambers.

11. A double-acting pneumatic actuator system, comprising:
a double-acting pneumatic actuator having first and second working chambers, as well as a moveable working part which is shiftable at a pressure difference in the first and the second working chambers;
a positioner supplying first and second pneumatic control signals output to the first and second working chambers, respectively, the positioner having at least one adjusting device for adjusting the first pneumatic control signal for the first working chamber, said adjusting device being designed such that the adjustment of the first control signal according to a control leaves the second control signal unaffected;
the actuator being connected to a pneumatic supply source, and, in a fully regulated state of the actuator, in the first and the second working chamber an average pressure value is determined with respect to pressures in the first and the second working chambers; and
for increasing a stiffness of the actuator, the positioner is designed in a manner to vary an average pressure value of the working chambers.

12. A system of claim 11 wherein the positioner varies said average pressure via the working chambers to increase it above a half of a supply pressure of the pneumatic supply source.

13. An actuator system according to claim 11 wherein the average pressure value of the working chambers is adjustable between a minimum and an approximately full supply pressure.

14. An actuator system according to claim 13 wherein the average pressure value of the working chambers is adjustable between 3 bar and 6 bar.

15. A method for operating a double-acting pneumatic actuator comprising first and second pneumatic working chambers wherein separate pneumatic control signals are applied to the working chambers, comprising the steps of:
determining an average pressure value of the first and the second working chambers in a fully regulated state of the actuator; and
for increasing or reducing respectively a stiffness of the actuator, the average pressure value of the working chambers is increased or decreased, respectively.
